(19) United States
(12) Patent Application Publication
(10) Pub. No.: US 2004/0186780 A1
(43) Pub. Date: Sep. 23, 2004

(54) Method and system for distributing media in a private radio network

(76) Inventors: Michael P. Short, Vancouver, WA (US); Ian M. Fink, Austin, TX (US)

Correspondence Address: Michael P. Short, 14034 SE 35th Loop, Vancouver, WA, 98683, US

(21) Appl. No.: 10/804,614

(22) Filed: Mar. 19, 2004

Related U.S. Application Data
(60) Provisional application No. 60/456,339, filed on Mar. 20, 2003.

(51) Int. Cl. G06F 17/60; H04K 1/00; H04L 9/00

(52) U.S. Cl. 705/14

(57) ABSTRACT

One or more embodiments of the systems and/or methods described herein may address locations that may be incapable of utilizing one or more systems and/or methods in related fields. According to one embodiment, a method and/or system may deliver audio and/or visual information to an audience represented by a collective of persons present in a selection of retail locations at any given moment. In another embodiment, advertisements may be customized to a specific venue and/or a group of venues. In one embodiment, a venue may use a computer system to distribute media such as audio and/or video information. In an alternative embodiment, one or more venues may comprise a portion of a private radio network system which may distribute media such as audio and/or visual media in accordance with one or more methods.

### PRIORITY CLAIM

This application claims benefit of priority of provisional application Serial No. 60/456,339 titled “VIRTUAL PRIVATE RADIO NETWORK” filed on Mar. 21, 2003, whose inventor is Michael P. Short.

### BACKGROUND OF THE INVENTION

1. Field of Invention

This invention relates generally to providing media services, such as audio and/or video, to one or more venues.

2. Background of Related Art

In general, Audio and visual services are provided to retail venues in fields related to radio and television broadcast automation, among others. For some time merchants have understood that an ambience created by media, including various displays and background music, add to their customers' experience in their establishments and venues and may enhance or contribute to sales. More recently, merchants have discovered that upon designing audio and/or audio-visual presentations after commercial radio and/or television broadcasters, they may realize additional benefits such as an increase in sales and/or customer presence in one or more venues. These are often called Private Radio Networks or Private Marketing Networks. However, one or more short-comings of many typical subscription-based media, such as music and/or video, services provides little or no customized advertising for a venue, especially for small venues such as hair salons, doctor offices, and/or golf pro shops, among others.

One or more services, methods, and systems that may provide customized media presentations within retail locations are evolving. Satellite delivery of customized programming is one example. Dedicated networks using private networks, commercial networks, and/or the Internet for delivery also has become offered. Each method carried a basic cost of infrastructure creating measures of affordability for retailers and/or merchants.

One example of an existing method in this field is the use of a standard CD (compact disc) player, among others, to facilitate a music-only output, requiring someone to change CDs periodically. Additionally some of these implementations include CD changing devices called auto-changers, to minimize intervention. Another example of an existing method in this field is a satellite receiver and dish programmed to receive media such as audio and/or audio-visual streams of programming for local presentation. Such a method allows for some location-specific customization of the programming.

### SUMMARY OF THE INVENTION

One embodiment of a private radio network system includes a computer system operable to distribute media such as audio and/or video in a wired or wireless fashion. The media may include music, news, streaming video, and/or advertisements, among others. The computer system may comprise a CPU and a memory medium coupled to the CPU. The memory medium may store program instructions which are executable by the server CPU allowing the computer system to: determine if an identification should be distributed; distribute the identification if the identification should be distributed; determine if an advertisement should be distributed; distribute the advertisement if the advertisement should be distributed; determine if media should be distributed; determine media to distribute, if media should be distributed; and distribute the media, after determining the media to distribute.

In one embodiment the media may be associated with one or more attributes. The computer system may be operable to determine and use the one or more attributes associated with the media. For example, an attribute may indicate the type of media. For instance, the media may be music, news, streaming video, advertisements, station IDs, and/or welcome messages, among others. In another embodiment, an attribute may indicate a length of the media or an alternate start and/or stop time. In an alternate example, an attribute may indicate a genre of the media. For instance, the attribute may indicate rock, classical, country, jazz, blues, or reggae, among others.

A venue or business may subscribe to the private radio network system. The venue may use the computer system described above to distribute media at the venue. The computer system may be coupled to an audio output device and/or video output device to distribute media. From time-to-time, the venue may receive updates to media and/or software for the computer system. For example, the media and/or software updates may include information requested by the venue. In another example, the private radio network system may update various music, advertisements, videos, or station announcements, among others. In one embodiment, the updates may be distributed to the venue through the United States Postal Service (USPS), Federal Express (FedEx), or United Postal Service (UPS), among others.

### BRIEF DESCRIPTION OF THE DRAWINGS

Other objects and advantages of the invention will become apparent upon reading the following detailed description and upon reference to the accompanying drawings in which:

FIG. 1 is a block diagram of one embodiment of a private radio network according to one embodiment;

FIG. 1A is a block diagram of one embodiment of a private radio network including media distribution access points according to one embodiment;

FIG. 1B is a block diagram of one embodiment of a private radio network including media distribution access points according to one embodiment;

FIG. 2A is a block diagram of a selection server system according to one embodiment;

FIG. 2B is a block diagram of a selection server system according to one embodiment;

FIG. 3 is a flowchart of a method that may be used with a selection server system according to one embodiment;

FIG. 4 is a flowchart of a method that may be used with a selection server system according to one embodiment;

FIG. 5 is a flowchart of a method that may be used with a selection server system according to one embodiment;

FIG. 6 is a flowchart of a method that may be used on a computer system of a private radio network according to one embodiment; and

FIG. 7 is a flowchart of a method that may be used on a media distribution computer system according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

The present invention relates to one or more systems and/or methods of providing a private radio network (PRN). A PRN may comprise one or more support networks and one or more computer systems.

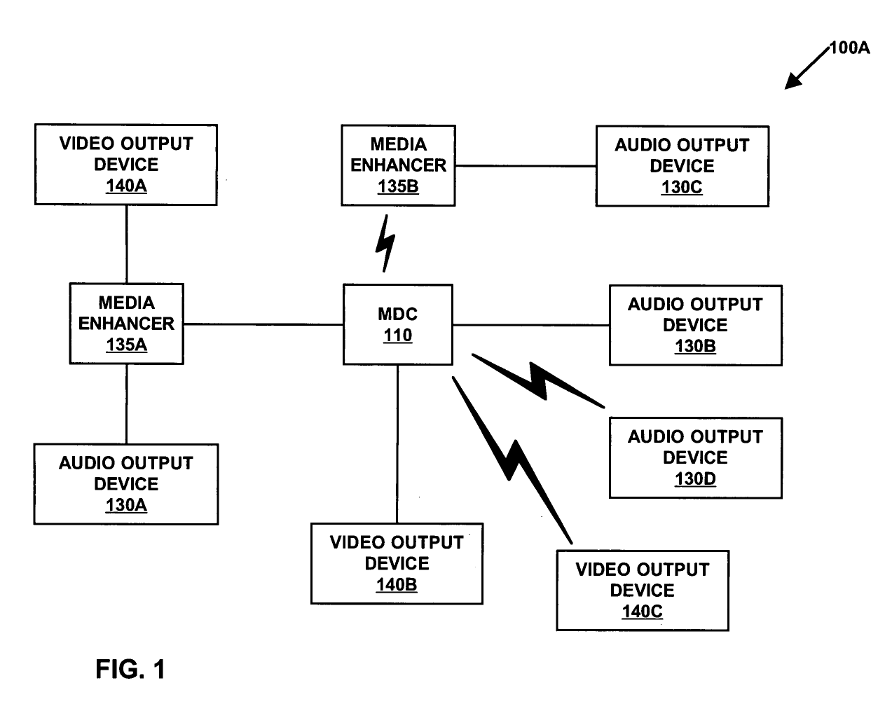

FIG. 1—Private Radio Network System

As shown in FIG. 1, a PRN 100 may comprise a media distribution computer (MDC) 110 for distributing media in various forms. MDC 110 may also be considered an information distribution computer system. Some forms may include audio and/or video, among others. Audio and/or video may be distributed by analog and/or digital signals from MDC 110. MDC 110 may comprise and use one or more memory mediums including one or more removable memory mediums for distributing the media.

In one embodiment, PRN 100 may comprise one or more media enhancers 135 coupled to MDC 110 in a wired or wireless fashion. In one instance, a media enhancer 135A may comprise audio and/or video amplification circuitry. In another instance, one or more of the media enhancers 135 may include circuitry that may provide one or more analog-to-digital and/or digital-to-analog conversions.

PRN 100 may also comprise one or more video output devices 140. For example, each of the video output devices 140 may comprise a video monitor operable to display one or more images or portions of images. In another example, each video output device 140 may also be operable to display a plurality of images and/or a plurality of images in a sequence, thereby creating a motion picture or streaming video.

PRN 100 may comprise one or more audio output devices 130. For example, one or more of the audio output devices 130 may include a speaker operable to output audio in one or more frequencies over one or more periods of time. In another example, one or more of the audio output device may include a plurality of speakers. In one embodiment, one or more of the video output devices and/or one or more of the audio output devices 130 may be coupled to MDC 110 in a wired or wireless fashion.

According to one embodiment, MDC 110 may be operable to allow one or more audio output devices 130 to operate synchronously with one or more video output devices 140. In an alternate embodiment, MDC 110 may be operable to allow one or more audio output devices 130 to operate asynchronously or independently of one or more video output devices 140.

In one embodiment, a venue may include PRN 100. Media comprised in a memory medium of MDC 110 may include audio and/or video in accordance with a classification of the venue. For example, a plurality of hair salons may be included in one classification. In another example, a subset of the hair salons may be included in another classification. For instance, the subset may be included in hair salons that cater to patrons above forty years of age. In another instance, the subset may cater to patrons in their twenties and/or below. Other examples may include automobile dealerships where subsets may include one or more types of automobiles such as FORDs, CHEVROLETs, sedans, sports cars, trucks, sport-utility vehicles, among others.

The memory medium may comprise media in the form of advertisements and/or promotions. The advertisements and/or promotions may be produced by the venue and/or a third-party associate of the venue. The advertisements may include advertisements of the venue and/or advertisements for one or more other venues. For example, a venue such as a coffee shop may include advertisements for coffee beans which may be purchased at the coffee shop. The coffee shop may include advertisements for an automobile dealership, hair salons, and/or airlines, among others.

In another embodiment, PRN 100 may be distributed throughout a geographic region. The geographic region may be of any size and/or shape. In this embodiment, PRN 100 may provide service to a plurality of venues 175. Each of the plurality of venues 175 may include a portion of PRN 100. Furthermore, each of the plurality of venues 175 may include one or more media distribution access points 150, as shown in FIG. 1A. Each of the media distribution access points 150 may be coupled to a network 160 in a wired or wireless fashion, and network 160 may be coupled to MDC 110 in a wired or wireless fashion. For example, media distribution access point 150E may be coupled to network 160 in a wired fashion. In another example, media distribution access point 150F may be coupled to network 160 in a wireless fashion, as shown in FIG. 1B. In one embodiment, media distribution access point 150A may be coupled to a media enhancer 135A. In another embodiment, media distribution access point 150A may be coupled to audio output device 130A and/or video output device 140A. In one embodiment, one or more of the media distribution access points 150 may receive, store, and/or buffer media for future distribution.

Network 160 may comprise a wired network, a wireless network or a combination of wired and wireless networks. For example, the network 160 may be a standard “wired” Ethernet network which may connect one or more of the media distribution access points 150 to MDC 110. Network 160 may include one or more wireless networks based on IEEE 802.11 and/or IEEE 802.16, for example. Network 160 may utilize one or more methods of multiple access and/or spatial reuse such as spread spectrum, frequency-hop spread spectrum (FSHH), time division multiple access (TDMA), code division multiple access (CDMA), frequency-division multiple access (FDMA), and/or channel assigned pass-bands, among others. Network 160 may include one or more DSL (digital subscriber line) and or cable (e.g., cable television) networks and/or infrastructures. For example, network 160 may include one or more of: cable modems, DSL modems, digital subscriber line access multiplexers (DSLAMs), broadband remote access servers (BRASs), metropolitan area networks (MANs), among others. Network 160 may form part of the Internet, or may couple to other networks, e.g., other local or wide area networks, such as the Internet.

Network 160 may be coupled to other types of communications networks, (e.g., other than the Internet) such as the public switched telephone network (PSTN). Network 160 may also be coupled to a wide area network (WAN), such as a proprietary WAN. Network 160 thus may be, or be coupled to, any of various wide area networks (WANs), local area networks (LANs), including the Internet. Network 160 may be coupled to MDC 110 where MDC 110 provides media to network 160 or to the various WANs, local area networks (LANs), including the Internet. In one embodiment, MDC 110 may include a broadband remote access server (BRAS). In another embodiment a BRAS may include MDC 110.

In one embodiment, a subset of the plurality of venues may receive the same media or portion of the media. For example, the subset may receive the same media or portion of the media in a broadcast and/or multicast format. In another example, the subset of venues may receive the same media or portion of the media included in one or more removable memory mediums. In another embodiment, at least one of the plurality of venues may receive different media or a portion of different media from another venue of the plurality of venues. For example, a first venue of the plurality of venues may receive media that differs from media received by a second venue of the plurality of venues where media may be specific to the first venue's and/or second venue's business, customer base, advertisements, and/or station identification, among others, respectively.

PRN 100 may also include a management information base (MIB) 170. MIB 170 may be a mechanism, such as a memory medium, which may allow the persistent storage and management of information needed by network 160 to operate. For example, in one embodiment of the invention, the MIB 170 may store a data structure, such as a table comprising a list of identification information and a corresponding list of the plurality of possible networks, venues, and/or services. The data structure may also store access information, which may comprise associated methods for providing data to the respective plurality of possible networks, venues, and/or services. The access information may further comprise access level and/or privilege level information. Thus, the data structure may comprise a table having a plurality of tuples, with each tuple having the identification information. In an alternate embodiment, as noted above, the data structures which store this information may be comprised in each of the media distribution access points 150, or may be provided in various other locations.

MIB 170 may store other information, such as a directory of all the elements (e.g., media distribution access points, computing devices, etc.) in the network, the topology of the network, characteristics of individual network elements, characteristics of connection links, performance and trend statistics, and any information which is of interest in the operation of network 160. For example, the MIB 170 may store the precise longitude, latitude, altitude and other geographic information pinpointing the location of each media distribution access point.

MDC 110 and/or media distribution access points 150 may include one or more identifications. An identification of the one or more identifications may be stored in a memory medium of MDC 110, MIB 170, and/or media distribution access points 150. In one embodiment, the memory medium may be removable. In another embodiment, an identification may be a geographic location. The geographic location may be stored in MDC 110 and/or media distribution access points 150. Alternatively, MIB 170 may store a geographic location of MDC 110 and/or media distribution access points 150.

In one embodiment, The MDC 110 and/or media distribution access points 150 may be identified by a “marking” or a MDC ID. The MDC ID may comprise internal or external components such as peripherals of a MDC and/or a media distribution access point. These internal or external components providing the MDC ID may comprise: a media access control (MAC) ID, CPU or processor ID, an internet protocol (IP) address, a subscriber identification module (SIM), a smart card, and an electronic serial number (ESN). The MDC ID may also comprise information stored in a memory medium of the MDC. This information may comprise: a cookie ID, a certificate ID, a biometric scan such as a retina scan, finger print, etc., or a string of characters. Combinations of these IDs may also serve as a MDC ID.

According to one embodiment, a memory medium or removable memory medium (RMM) of MDC 110 may comprise one or more computer-decodable files for the reproduction media such as audio and/or video which may be included in one or more data structures or data files (DFs). A data structure or data file (DF) may be encrypted by any of various encryption methods, algorithms, and/or mechanisms to ensure security, authentication, and/or authorization. The RMM may comprise a RMM ID. The RMM ID may be used to verify authenticity of data, its use with MDC 110, and/or its use with another RMM.

The RMM may further comprise program instructions to allow MDC 110 read and/or decode DFs which may be comprised in the RMM or another memory medium of MDC 110. The program instructions may, also, comprise an operating system (OS) such as Windows 2000, Windows XP, PocketPC, FreeBSD, NetBSD, BSDi, Linux, among others.

In one embodiment, the RMM may also comprise one or more DFs which may allow program instructions to distribute one or more weighted play lists, schedule programming instructions, distribute specific DFs such as video and/or songs, advertisements, and/or station announcements or identifications. In another embodiment, a DF comprised in the RMM may be written by MDC 110. This functionality may be comprised in a system and/or method providing accounting of playback of media, such as songs and/or video played, announcements made, and/or advertisements distributed. The DF used for accounting may be encrypted by any of various encryption methods, algorithms, and/or mechanisms to ensure security, authentication, and/or authorization.

According to one embodiment, a set of program instructions, comprised in the RMM, may only be executable on MDC 110 if MDC 110 has a specific MDC ID. In another embodiment, a DF comprised in the RMM may only be decoded on MDC 110 if MDC 110 includes a specific MDC ID. Further, the DF may cause and/or allow a set of program instructions to only execute on MDC 110 if MDC 110 includes a specific MDC ID.

In another embodiment, large DFs may be comprised in a DVD (digital video disc) or similar memory media because of its storage capacity. The DVD may be a first RMM and program instructions may also be comprised in the DVD. A key may be specific to MDC 110 may be comprised in a second RMM. The second RMM may have a smaller storage capacity and/or a smaller physical size. For example, the second RMM may be a compact flash (CF) card or another variation of an EEPROM. The key may be used to decrypt, authorize, and/or authenticate the use of the DFs comprised in the first RMM. DFs and/or program instructions may be comprised in the second RMM, as well. Thus, the combination of the first RMM and the second RMM may be used to allow MDC 110 to function as desired. In an alternative embodiment, the key may be input through an input device of MDC 110 or a media distribution access point 150. For example, the input device may be a keyboard or keypad. In another example, the input device may be a biometric input device. In various other embodiments, other computer system inputs may be utilized.

Memory Medium and Carrier Medium

One or more of the systems described above, such as MDC 110, media distribution access points 150, media enhancer 135, audio output devices 130, video output devices 140, and MIB 170 may include a memory medium on which computer programs or data may be stored. For example, a MDC 110 may store a data structure and/or data files as described above comprising information regarding identification information, media data, and/or accounting data. MDC 110, MIB 170, and/or media distribution access points 150 may further store program instructions for accessing these data structures or files and using the information therein to properly provide media such as audio and/or video media, to distribute weighted play lists, schedule media programming, distribute specific media, advertisements, or station announcements.

The term “memory medium” is intended to include various types of memory or storage, including an installation medium, e.g., a CD-ROM, DVD (digital video disc), floppy disk, a random access memory or computer system memory such as DRAM, SRAM, EDO RAM, Rambus RAM, NVRAM, EPROM, EEPROM, flash memory etc., or a non-volatile memory such as a magnetic media, e.g., a hard drive, or optical storage. In one embodiment, the memory medium may be removable and/or a portion may be removable. The memory medium may comprise other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution. The memory medium may also be a distributed memory medium, e.g., for security reasons, where a portion of the data is stored on one memory medium and the remaining portion of the data may be stored on a different memory medium. Also, the memory medium may be one of the networks to which the current network is coupled, e.g., a SAN (Storage Area Network).

Also, each of the systems described above may take various forms, including a personal computer system, mainframe computer system, workstation, network appliance, Internet appliance, personal digital assistant (PDA), television system or other device. In general, the term “computer system” can be broadly defined to encompass any device having a processor which executes instructions from a memory medium.

The memory medium in one or more of the above systems thus may store a software program or data for performing or enabling the methods and system of the PRN.

A CPU or processing unit in one or more of the above systems executing code and data from a memory medium comprises a means for executing the software program according to the methods or flowcharts described herein.

Various embodiments further include receiving or storing instructions and/or data implemented in accordance with the present description upon a carrier medium. Suitable carrier media include memory media as described above, as well as signals such as electrical, electromagnetic, optic, or other forms of analog or digital signals, conveyed via a communication medium such as networks and/or a wired and/or a wireless link.

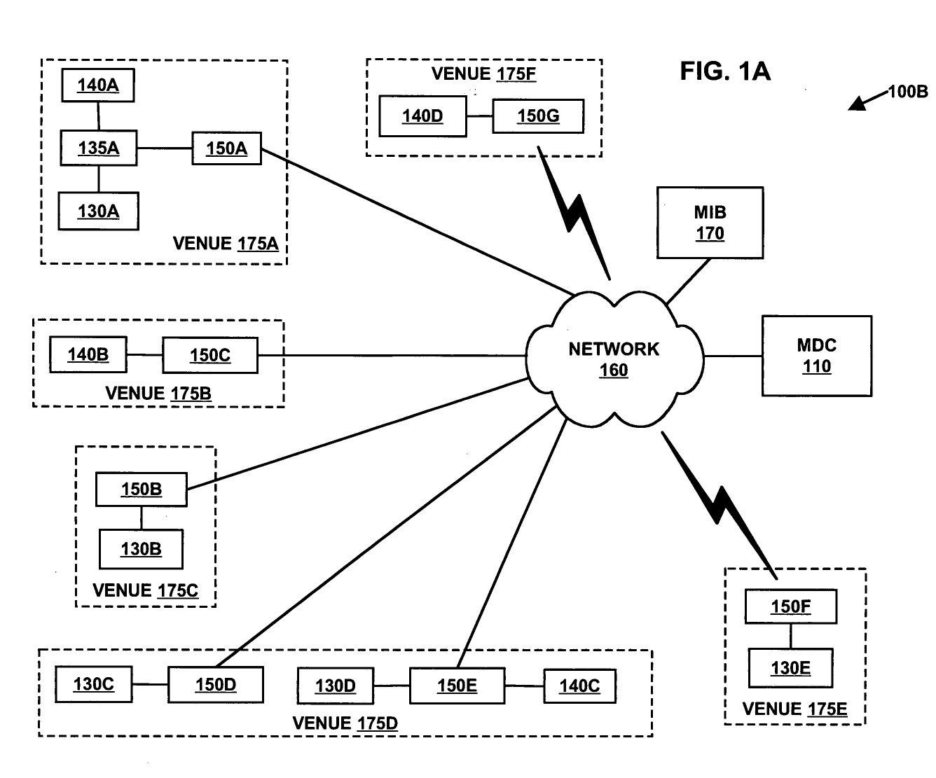

FIG. 2—Selection Server System and Customization of the Venue's Environment

According to one embodiment, a subscribing venue of the PRN may have an ability to provide customized advertising of goods and/or services of the venue. Further, the subscribing venue may choose the type and/or genre of media distributed at the venue. The subscribing venue may utilize a selection server system (SSS) 600A or SSS 600B, shown in FIG. 2A and FIG. 2B respectively, to aid in customizing media for the venue's environment.

SSS 600 may comprise an interface server (IS) 610. According to one embodiment, IS 610 may be a web server. In another embodiment, IS 610 may be an email server. According to another embodiment, the IS 610 may be a custom server to interface with a client software other than a web browser. In an alternative embodiment, IS 610 may include software and/or hardware to present audio choices and/or receive audio/speech and/or dual tone multi-frequency (DTMF) commands or selections. For example, IS 610 may be a voice extensible markup language (VoiceXML) server. In another example, IS 610 may be operable to interface with a VoiceXML server. Various embodiments of IS 610 may present the venue subscriber with options and may receive responses to the options. IS 610 may require an authentication, such as a username and password, to access an account associated with the subscribing venue.

In one embodiment, SSS 600 may comprise an advertisement server (AS) 620. The AS 620 may receive and/or store possible advertisements available to one or more subscribing venues. These advertisements may be stored in a memory medium or in a database of the AS 620. The AS 620 may utilize a second server, where the second server may store the advertisements in a memory medium or in a database.

According to another embodiment, SSS 600 may comprise a media server (MS) 630. The MS 630 may receive and/or store possible media available to one or more subscribing venues. The MS 630 may also receive and/or store media available to the general public. The media may be stored in a memory medium or in a database of the MS 630. The MS 630 may utilize a second server, where the second server may store the media in a memory medium or in a database.

In another embodiment, SSS 600 may comprise a network 607, where the network 607 may comprise a wired network, a wireless network or a combination of wired and wireless networks. For example, the network 607 may be a standard “wired” Ethernet network which may connect IS 610, AS 620, and MS 630 together, as shown in FIG. 2A. The network 607 may connect other servers, as well.

SSS 600 may comprise a network 605. Network 605 may comprise a wired network, a wireless network or a combination of wired and wireless networks. For example, the network 607 may be a standard “wired” Ethernet network which may connect to IS 610. In one embodiment, network 605 may connect IS 610, AS 620, and MS 630 together, as shown in FIG. 2B. Further, network 605 may connect other servers, in addition. In a one embodiment, network 605 may be coupled to Internet 178.

The network 605 may be coupled to other types of communications networks, (e.g., other than the Internet) such as a PSTN, whereby a server coupled to network 605 may send and receive information from/to the PSTN or other communication networks. The network 605 may also be coupled to a wide area network (WAN), such as a proprietary WAN. The network 605 thus may be, or be coupled to, any of various WANs, local area networks (LANs), corporate networks, including the Internet 178.

According to another embodiment, a representative of the subscribing venue may use a computing device to interface with IS 610, where the representative may be able to select the type and/or genre of music for the subscribing venue. Accordingly, the representative interfaces with IS 610 for one or more selections. The IS 610 may present one or more genre selections. One or more genres may be selected for distribution within the subscribing venue. Further, genre “play times” or schedules may be selected, as well. For example, the subscribing venue may have a different type of clientele during the day than it does at night.

In various embodiments of subscription-based systems, there may be one or more fees associated with one or more genre selections. For example, a genre of top-40 may have a different or a higher fee than a genre of classic country or new age. Other examples of genres may comprise reggae, blues, classical, “elevator music”, rhythm and blues, jazz, salsa, and/or tropical, among others. Moreover, some genres may comprise sub-genres, such as jazz may comprise classic jazz and/or modern jazz, among others. Fees for scheduling genre play times may be applicable, as well. In one embodiment, these fees may be determined by an agent of the PRN system. These fees may also or otherwise be determined by a demand-based system and/or method. In another embodiment, the data, stored and selections of media or genres, may be used with an adaptive algorithm such as a neural network which may include a Bayesian estimator and/or another similar probability estimator to set fees or discounts of media selections.

“Heavier” weighted play lists may be available for selection by the representative of the venue. These play lists may have a discount associated with them, since one or more media distributions may be desired to be distributed more frequently by the PRN system.

In another embodiment, the subscribing venue may have its venue's “station identification” and/or “welcome announcement” distributed periodically. This may help with marketing or branding of the venue, among others. For example, the representative of the venue, interfacing with IS 610, may select a standard station identification based upon information known about the subscribing venue. In another example, the representative may submit and/or upload “copy” to the IS 610, where the copy will be integrated into the media distribution for the subscribing venue. For instance, the representative may submit and/or upload media, for the station identification, to IS 610.

According to another embodiment, the subscribing venue may have the ability to provide or produce the specific advertising for distribution in the venue. For example, the subscribing venue is going to have a sale on widgets next month and wishes to have in-venue advertising to remind the venue's customers about the sale on widgets while customers shop. In another example, the subscribing venue may be a doctor's office where it is desired to have health care announcements and/or video clips as advertisements. The subscribing venue may have the advertisement produced by an agent of the PRN system or may produce the advertisement itself and/or via a third party, by a time-frame suitable to have the advertisement as an available option for distribution. For instance, an option for selecting one or more advertisements on widgets may be presented to and/or selected by the representative. Further, an option for uploading one or more advertisements may be presented to and/or selected by the representative, where the data for one or more selection presentations and/or storages may be comprised in a memory medium of the AS 620 and/or IS 610. One or more of the uploaded advertisements may be comprised in a list of available advertisements for the subscribing venue. According to another embodiment, the subscribing venue's representative may select one or more outside advertisements, as well. Any selected advertisements, described herein, may be comprised in a RMM and/or carrier medium distributed to the subscribing venue. In one embodiment, the subscribing venue may select to not have advertisements. Additional fees may be applicable for this selection.

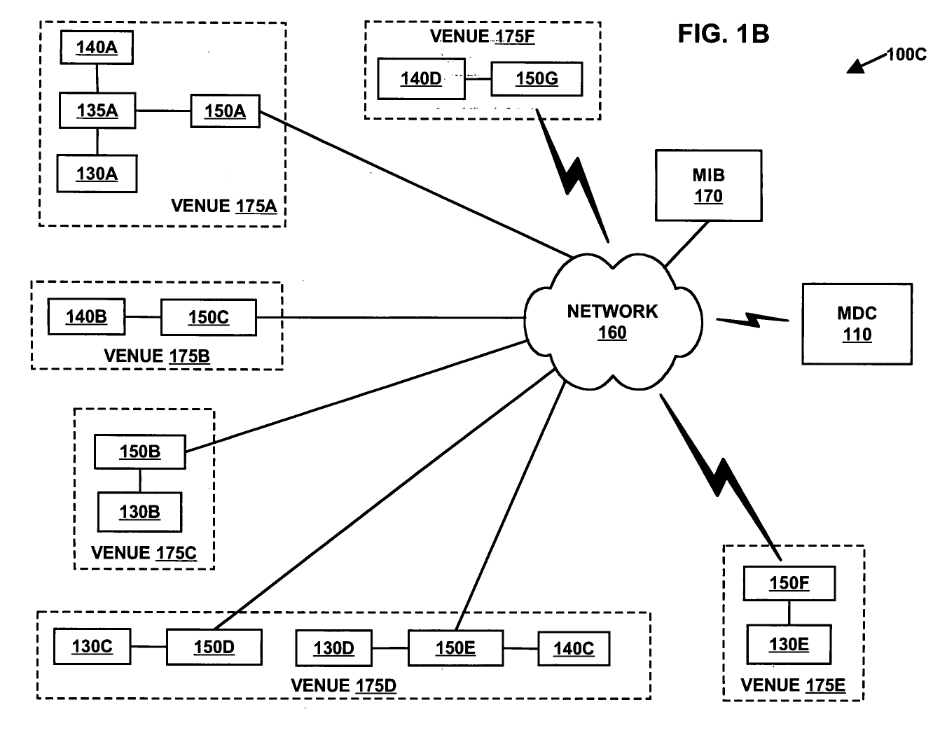

FIGS. 3-5—Outside Advertisement

With a subscription based system such as the PRN system, advertisements may be sold for audio and/or video distribution at one or more subscribing venues. In one embodiment, a subscribing venue may reduce its periodic subscription fee by electing to have a number of advertisements distributed at its location. For example, a subscribing venue such as a hair salon may elect to have a number of advertisements about hair care products (e.g., Paul Mitchel, Vidal Sasoon, etc.) for a reduced subscription fee. The PRN owner and/or operator may collect a fee from the advertisers for the advertisement distributions. Moreover, the venue subscriber may even be paid a fee for the number of advertisements distributed.

FIG. 3 is a flowchart depicting a method that may be used on one or more computer systems comprised in SSS 600. According to one embodiment, the method may be comprised in server software which may be comprised in or called from other server software. In another embodiment, the method may be used with a web server system. In an alternative embodiment, the method may be used in with a voice/speech commanded or operable server such as a VoiceXLM server.

The method receives a number of outside advertisements the subscribing venue desires, as shown in block 410. In one embodiment, the number of advertisements may be based on a time period such as seven hundred and twenty advertisements to be distributed within a thirty-day time period. In another embodiment, there may be a threshold of the number of advertisements that may be accepted. A threshold may be useful, since the PRN functions to distribute entertainment media such as audio and/or video as well. Next the method proceeds to block 420 where a number of outside advertisements may be recorded. In this step, the information may be stored in a memory medium or in a database.

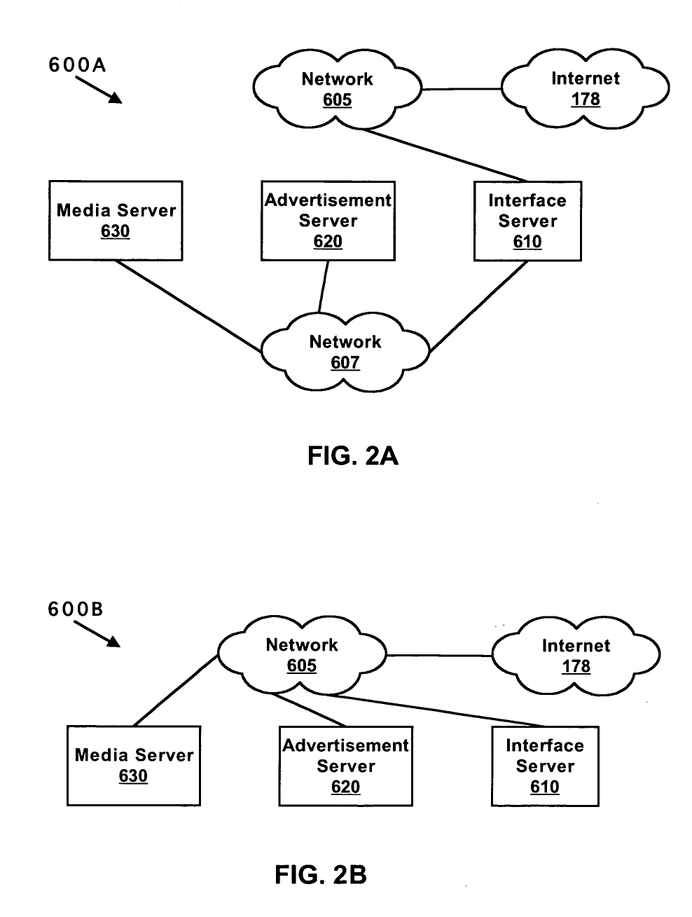

As mentioned above, a venue such a hair salon may desire to have a type of advertising, such as advertising for hair care products, distributed. FIG. 4 is a flowchart depicting a method that may be used on one or more computer systems comprised in SSS 600. According to one embodiment, the method may be comprised in server software which may be comprised in or called from other server software. In another embodiment the method may be used with a web server system. In an alternative embodiment, the method may be used in with a voice/speech commanded or operable server such as a VoiceXLM server.

The method may receive a type of advertising to be distributed at block 400. In one embodiment, the method may only receive one or more certain types of advertisements according to possible information known about the subscribing venue. For example, it may be desired that a subscribing venue such as a Chevrolet dealership to not distribute advertisements for Ford automobiles. Further, certain types of advertisements may not be appropriate for the clientele of the subscribing venue. An example of this may be that an advertiser may not want her advertisements for snow skis be distributed to a subscribing venue selling surfboards and/or other warm water activities.

The method then proceeds to block 410 where, as above, the method receives a number of outside advertisements the subscribing venue desires. Next the method to block 430 where the type and the number of outside advertisements may be recorded. In this step, information may be stored in a memory medium or in a database.

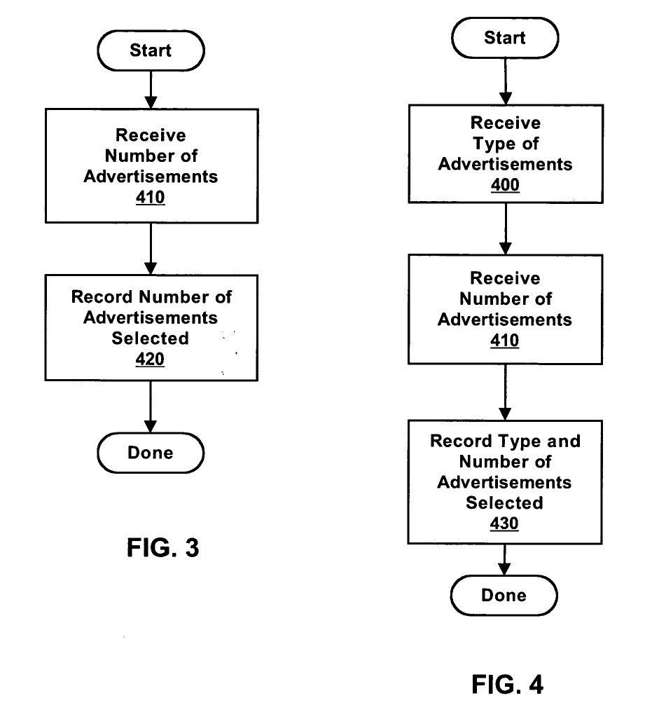

In an alternate embodiment, the genre of music selected for the venue may also determine the appropriateness of an advertisement as depicted in an alternate method in of FIG. 5. There may be a threshold to the number of different types of advertising a subscribing venue may distribute. FIG. 5 is a flowchart depicting a method that may be used on one or more computer systems comprised in SSS 600. According to one embodiment, the method may be comprised in server software which may be comprised in or called from other server software. In another embodiment the method may be used with a web server system. In an alternative embodiment, the method may be used in with a voice/speech commanded or operable server such as a VoiceXLM server.

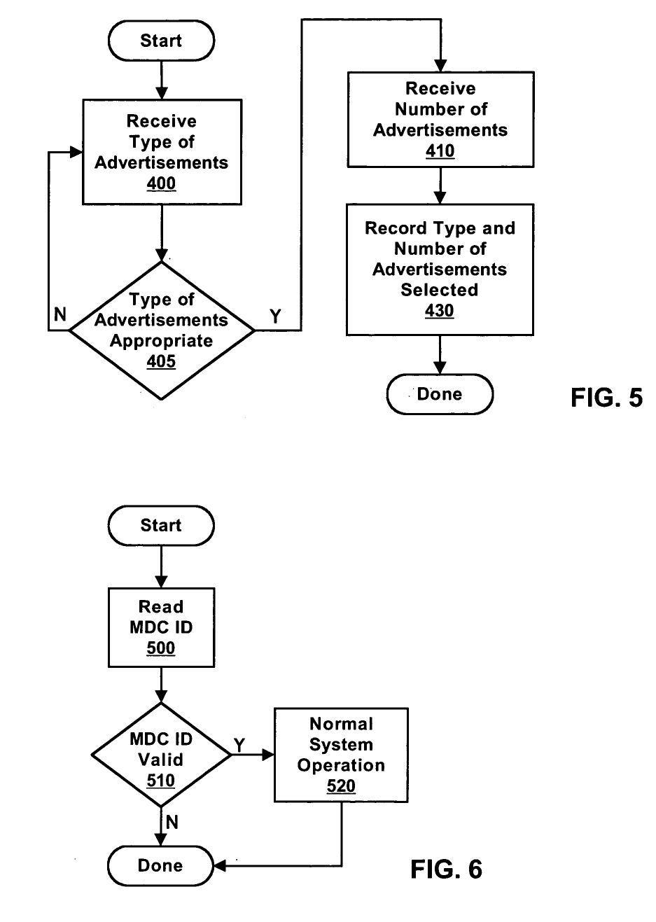

FIG. 6—Removable Memory Medium Identification Use

FIG. 6 depicts a flowchart of a method that may be included in a computer system. In step 500, a MDC ID is read. In one embodiment, the MDC ID may be read from a removable memory medium. In another embodiment, the MDC ID may be read from an input device of the computer system. For example, the input device may be a keyboard or keypad. In another example, the input device may be a biometric input device. In various other embodiments, other computer system inputs may be utilized.

Next the method proceeds to block 510, where the validity of the MDC ID may be determined determined. In one embodiment, the MDC ID may be require to match a second MDC ID or a derivative of the MDC ID, such as a hash or encrypted value of the MDC ID, for the MDC ID to be considered valid. In another embodiment, the MDC ID may be required to match or be a derivative of a DF, a portion of a DF, and/or a part of an executable code read from a memory medium, for the MDC ID to be recognized as valid. If the method determines the MDC ID is valid, the method proceeds to block 520.

As block 520 shows, normal method and/or system operation may occur. This may comprise any systems and/or methods described herein. If the MDC ID is not valid the computer system may function as desired.

Method of Station ID, Advertisement, and Media Distribution and Accounting

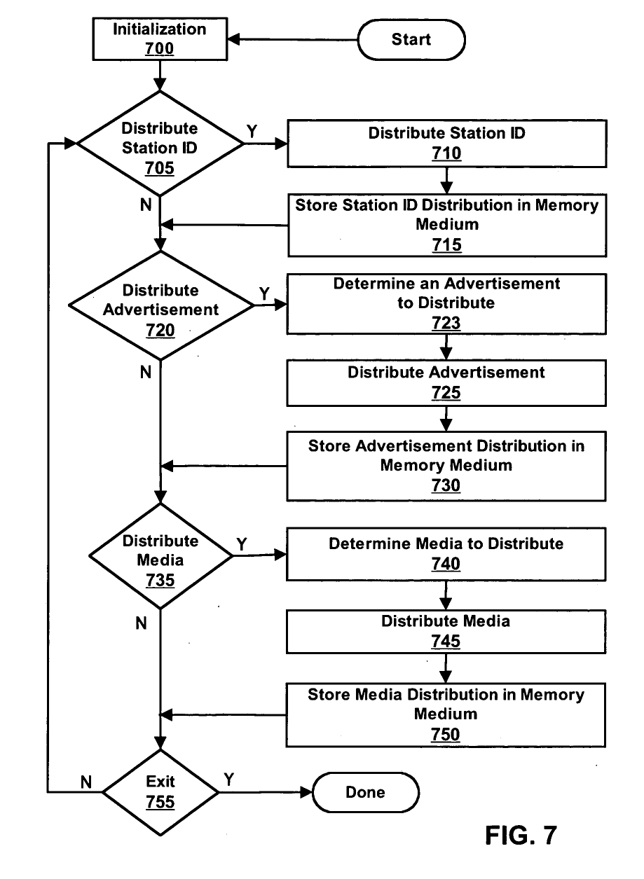

FIG. 7 is a flowchart illustrating method that may be executed on a computer system. In one embodiment the computer system may be MDC 110. In one embodiment, portions of this method may also be included in a creating of playlist. In block 700, an initialization may occur. In one embodiment, the initialization step may be a “no operation” step. In another embodiment, step 700 may comprise one or more software routines and/or methods for one or more desired computer system operations.

One or more of the software routines may serve to initialize one or more data structures utilized by successor steps in the method of FIG. 7. For example, step 700 may read in data from a memory medium of the computer system. This data may comprise one or more previous states of the system. One of the states may comprise a number of station IDs and/or timestamps of distribution. Another state may comprise a number of advertisements and/or timestamps of advertisements that may have been distributed. Likewise, one state may comprise a number of media and/or timestamps of distribution by the computer system.

Next the method proceeds to block 705. At this block the method may determine if a station ID should be distributed. In one embodiment, the decision may be based upon a time period after a previous station ID distribution. The previous station ID distribution may have not occurred, so the method may determine that a station ID distribution is in order. In another embodiment, the method may determine to distribute a station ID after a threshold of advertisements and/or media distributions have occurred.

If the method does not determine that a station ID is in order, the method proceeds to block 720. If so, the method proceeds to block 710 where the station ID is distributed. Next the method proceeds to block 715. Here the station ID distribution may be recorded in a memory medium or database. The data recorded here may comprise a timestamp. According to one embodiment, the method may increment a counter. In another embodiment, the data recorded at this step may stored in removable memory medium of the computer system. Next the method proceeds to block 720.

At block 720, the method determines if an advertisement should be distributed. According to one embodiment above, a subscribing venue may have opted out of having advertisements. If this is true, then the method proceeds to block 735. In an alternative embodiment, the method may determine that an advertisement is in order based upon a time period after a previous or first advertisement. In another embodiment, the method may determine to distribute an advertisement based upon the time of day. According to one embodiment, the method may determine that an advertisement distribution is in order based upon a minimum and/or a maximum number of advertisements to distribute. If the method determines not to distribute an advertisement, the method proceeds to block 735. If so, the method proceeds to block 723.

As block 723 shows, the method determines an advertisement to distribute. In one embodiment, the subscribing venue may only have one advertisement to distribute. If this is the case, the method then proceeds to block 725. In another embodiment, the subscribing venue may have a plurality of advertisements to distribute. Each of the plurality of advertisements for distribution may comprise data that could direct the method in its distribution. In one embodiment, an advertisement may have a preferred time of day to be distributed. For example, a lunch special could be advertised during one or more hours of lunch for a venue. In contrast, in an alternative embodiment, the advertisement may have a time period of day to not be distributed. For instance, it may be distastefully, during lunch hours, to have certain advertisements or types of advertisements distributed. In another embodiment, the advertisement may have a minimum and/or maximum frequency of distribution.

Once an advertisement is determined to be distributed, the method proceeds to block 725, where the advertisement is distributed. Next the method proceeds to block 730, where the advertisement's distribution may be recorded in a memory medium. The information recorded here may include a timestamp. The method may increment also a counter. According to one embodiment, the information recorded at this step may be stored in a removable memory medium of the computer system. Next the method proceeds to block 735.

As block 735 illustrates, the method determines if a media is to be distributed. In one embodiment, the subscribing venue may not have any media to distribute. If this happens to be the case, then the method proceeds to block 755. In another embodiment, the subscribing venue has a plurality of media to distribute where the method proceeds to block 740.

Block 740 may comprise one or more software routines and/or methods to determine media for distribution. In one embodiment, each media may have one or more attributes associated with the media. For example, the media may be comprised in a data structure or DF as described above. The data structure or DF may also comprise one or more memory mediums and/or carrier mediums associated with the media, as well. In various embodiments of the present invention, one or more attributes may describe the media and/or allow one or more software routines and/or methods to distribute the media or portions of the media as desired.

According to one embodiment, one or more attributes may comprise one or more alternate start and/or stop times. For example, media may include a news broadcast which may include a plurality of news stories. One or more start and/or stop attributes may allow a computer system to distribute a subset of the plurality of news stories. In another example, various portions of audio such as a portion piece of music may be distributed without distributing the piece of music in its entirety. Similarly, video images and/or streaming video may be distributed in one or more portions, as well. In one embodiment, start and stop attributes may comprise one or more time indexes. For instance, a time index may have an arbitrary precision. In another instance a time index may have a precision of one one-thousands of a second, or greater precision. In one embodiment, the computer system and/or MDC 110 may comprise one or more timing elements of arbitrary precision.

According to one embodiment, an attribute associated with the media may indicate that the media may be comprised in one or more genres, themes, and/or types. For instance, the attribute may indicate that the media comprises jazz. In another instance, the attribute may indicate the media comprises news.

In another embodiment, an attribute associated with the media may indicate a frequency of distribution. For example, the attribute may indicate that the media may be distributed every fifteen minutes. In another example, the attribute may indicate that the media may be distributed at least five times per day or five times per hour, among other variations. For instance, the attribute may indicate a potential frequency of distribution with a numeric rating on a scale. The scale may be divided into decades, for example. Furthermore, the numeric rating may be used by a random method and/or software routine. Moreover, the numeric rating may be used set by or used with an adaptive method or system such as a neural network which may include a Bayesian estimator and/or another similar probability estimator.

In one embodiment, an attribute associated with the media may indicate a time or time-period of distribution. For instance, the attribute may indicate that the media should be distributed during lunch-time hours or “happy hour”. In another instance, the attribute may indicate that the media may be distributed during a time period such as the first five minutes of every hour. In an alternate instance, the attribute, may indicate that the media be distributed at an exact time of day or a next immediate distribution if another media is being distributed at the exact time of day. In one embodiment, the computer system and/or MDC 110 may comprise one or more timing elements of allowing a time to be determined and/or a time period of time within a time to be determined.

According to another embodiment, an attribute associated with the media may indicate a time or time-period where the media may not be distributed. As mentioned above, there may be media which may be inappropriate to distribute during lunch-time hours or similar situations, among others.

In one embodiment, an attribute associated with the media may indicate a length and/or an amount of time. For example, the length and/or amount of time may be a zero length and/or amount of time, in one instance.

According to another embodiment, an attribute associated with the media may indicate a beat or timing of the media. The beat or timing of the media may be used by a method or software routine to smooth transitions between two media distributions.

Various other embodiments of the present invention may comprise other attributes which may allow the methods and/or systems of the present invention to function as desired.

The method then proceeds to block 745, where the media is distributed. Following this, the method proceeds to block 750, where distribution of the media may be stored in a memory medium. The information stored may comprise a timestamp. The method may increment a counter. In another embodiment, the information stored may be stored in a removable memory medium of the computer system. Next the method proceeds to block 755.

As block 755 shows, the method determines if it may cease. In one embodiment, this block may be omitted; thus, block 755 may be effectively be replaced by block 705. In another embodiment, the method may use one or more of the data recorded above to determine if the method should cease. The method may base this exit upon a time period of day, such as only to operate during normal hours of business of the subscribing venue. For example, the method may exit at or around the close of business of the subscribing venue. According to another embodiment, the method may pause, at this step, until a time is determined to be included in normal business hours.

In one embodiment, the information stored on the removable memory medium may be utilized by the PRN system for accounting purposes, systems, or methods. In another embodiment, the removable memory medium is sent to an agent of the PRN system. According to another embodiment, the data and/or information recorded in the removable memory medium, as described above, may be used to ensure distribution of advertisements over a period of time. For example, this may help ensure that MDC 110 was operating in its function in the distribution of the advertisements over the period of time. According to an alternate embodiment, all accounting of media distribution may be analyzed by the PRN system. For instance, this may help in providing one or more statistical analyses.

Distribution and Return

In one embodiment, the PRN system may differ from traditional digital media distribution systems. For example, a removable memory medium may be distributed to a subscribing venue by a shipping method and/or system, wherein the data or a portion of the data comprised in the removable memory medium is not distributed to the subscribing venue over a network. For instance, the removable memory medium may be shipped to the subscribing venue through the United States Postal Service (USPS), Federal Express (FedEx), or United Postal Service (USPS), among others. In one embodiment, the content of the removable memory medium may be licensed to the subscribing venue. For example, the media for distribution at the subscribing venue may be considered marketing promotional material, among others.

According to another embodiment, information such as data structures and/or data files included in a removable memory medium may be self-expiring and/or unusable by a venue after a period of time transpiring. In one embodiment, the removable memory medium may not be usable by the venue after the removable memory medium is unpackaged. For instance, the removable memory medium may contain chemicals and/or compounds that, when exposed to an environment of MDC 110 and/or the venue, may allow the removable memory medium to become unusable to the subscribing venue after a period of time has transpired.

In another embodiment, new media may become available which may be included in a second removable memory medium may be distributed to the subscribing venue. According to one embodiment, a first removable memory medium, issued to the subscribing venue, may be returned to the PRN system, where this may aid in accounting and/or one or more systems and/or methods described above.

Frequent Media

In one embodiment, frequent media and/or advertising updates may occur. For example, a radio or television station may distribute traffic and/or weather updates. Another example, the radio or television station may distribute weather updates for the area. Likewise, MDC 110 or media distribution access points 150 coupled to network 160 may distribute frequent media and/or advertising, wherein these media and/or advertising may not be initially comprised in a removable memory medium. In another example, a subscribing venue such as an airport, the PRN system may provide flight schedule update to the subscribing venue's MDC 110 or one or more media distribution access points 150, where the MDC 110 and/or media distributions access points will then distribute such information.

It is noted that the present invention can be used for a plethora of applications and is not limited to the applications shown and/or described herein. In other words, the applications described herein are exemplary only, and the methods described herein may be used for any of various purposes and may be stored in and execute on any of various types of systems to perform any of various applications.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. An computer system comprising:
a CPU;
a memory medium coupled to the CPU, wherein the memory medium stores program instructions which are executable by the server CPU to:
determine if an identification should be distributed;
distribute the identification if the identification should be distributed;
determine if an advertisement should be distributed;
distribute the advertisement if the advertisement should be distributed;
determine if media should be distributed;
determine media to distribute, if media should be distributed; and
distribute the media, after determining the media to distribute;
wherein the computer system is operable to distribute the media.

2. The computer system of claim 1, wherein the program instructions are further executable by the server CPU to:
store an occurrence of distributing the identification.

3. The computer system of claim 1, wherein the program instructions are further executable by the server CPU to:
store an occurrence of distributing the advertisement.

4. The computer system of claim 1, wherein the program instructions are further executable by the server CPU to:
store an occurrence of distributing the media.

5. The computer system of claim 1, wherein the program instructions are further executable by the server CPU to:
determine one or more attributes associated with the media.

6. The computer system of claim 5, wherein an attribute of the one or more attributes associated with the media indicates a type of media.

7. The computer system of claim 5, wherein an attribute of the one or more attributes associated with the media indicates length of the media.

8. The computer system of claim 5, wherein an attribute of the one or more attributes associated with the media indicates a beat of the media.

9. The computer system of claim 5, wherein an attribute of the one or more attributes associated with the media indicates an alternate start of the media;
wherein the program instructions are further executable by the server CPU to:
start distributing the media at the alternate start of the media.

10. The computer system of claim 5, wherein an attribute of the one or more attributes associated with the media indicates an alternate stop of the media;
wherein the program instructions are further executable by the server CPU to:
stop distributing the media at the alternate stop of the media.

11. The computer system of claim 5, wherein an attribute of the one or more attributes associated with the media indicates an alternate start of the media.

12. A carrier medium comprising program instructions for distributing information, wherein the program instructions are computer-executable to:
determine if an identification should be distributed;
distribute the identification if the identification should be distributed;
determine if an advertisement should be distributed;
distribute the advertisement if the advertisement should be distributed;
determine if media should be distributed;
determine media to distribute, if media should be distributed; and
distribute the media, after determining the media to distribute.

13. The carrier medium of claim 12, wherein the program instructions are further executable to:
store an occurrence of distributing the identification.

14. The carrier medium of claim 12, wherein the program instructions are further executable to:
store an occurrence of distributing the advertisement.

15. The carrier medium of claim 12, wherein the program instructions are further executable to:
store an occurrence of distributing the media.

16. The carrier medium of claim 12, wherein the program instructions are further executable to:
determine the media to distribute.

17. The carrier medium of claim 12, wherein the program instructions are further executable to:
determine one or more attributes associated with the media.

18. The carrier medium of claim 17, wherein an attribute of the one or more attributes associated with the media indicates a type of media.

19. The carrier medium of claim 17, wherein an attribute of the one or more attributes associated with the media indicates length of the media.

20. The carrier medium of claim 17, wherein an attribute of the one or more attributes associated with the media indicates a beat of the media.

21. The carrier medium of claim 17, wherein an attribute of the one or more attributes associated with the media indicates an alternate start of the media;
wherein the program instructions are further executable by the server CPU to:
start distributing the media at the alternate start of the media.

22. The carrier medium of claim 17, wherein an attribute of the one or more attributes associated with the media indicates an alternate stop of the media;
wherein the program instructions are further executable by the server CPU to:
stop distributing the media at the alternate stop of the media.

23. The carrier medium of claim 17, wherein an attribute of the one or more attributes associated with the media indicates an alternate start of the media.

24. A method for selecting and distributing information in an information distribution system, the method comprising:
an information selection server indicating a possible selection of information to a user;
selecting information for distribution from the possible selection of information;
receiving the information for distribution;
a computing device distributing the information for distribution.

25. The method of claim 24, wherein said receiving includes receiving a removable memory medium which includes the information for distribution.

26. The method of claim 24, wherein said selecting the information for distribution includes selecting audio information.

27. The method of claim 26, wherein the audio information includes an advertisement.

28. The method of claim 26,
wherein the audio information includes a promotion.

29. The method of claim 24, wherein said selecting the information for distribution includes selecting video information.

30. The method of claim 29,
wherein the video information includes an advertisement.

31. The method of claim 29,
wherein the video information includes a promotion.

32. The method of claim 24,
wherein a venue comprises the computing device;
wherein a representative of the venue performs said selecting.

33. The method of claim 24,
wherein the computing device is operable to be coupled to one or more audio output devices.

34. The method of claim 24,
wherein the computing device is operable to be coupled to one or more video output devices.

35. The method of claim 24, wherein said indicating includes indicating the possible selection of information in a HTML format.

36. The method of claim 24, wherein said indicating includes indicating the possible selection of information in an audio format.

37. The method of claim 24, wherein said indicating includes indicating the possible selection of information in an electronic mail (email) format.

38. The method of claim 24, wherein said indicating includes indicating the possible selection of information with an embedded program.

39. The method of claim 24, wherein said indicating includes indicating the possible selection of information in an embedded script.

40. The method of claim 24, wherein said selecting information for distribution from the possible selection of information includes sending a selection from a communication device.

41. The method of claim 40,
wherein the selection is in an audio format.

42. The method of claim 41, wherein the audio format includes speech.

43. The method of claim 41, wherein the audio format includes one or more dual tone multi-frequency (DTMF) formats.

44. The method of claim 24,
wherein the selection is in a text format.

45. The method of claim 24, wherein said selecting information for distribution from the possible selection of information includes using a voice extensible markup language (VoiceXML) format.

46. The method of claim 24, wherein said indicating includes using a voice extensible markup language (VoiceXML) format.

47. The method of claims 24, wherein said selecting includes selecting information from a genre.

48. An information distribution system comprising:
a network;
one or more media distribution access points coupled to the network, wherein each distribution media access point is operable to be coupled to one or more output devices, wherein each media distribution access point operable to communicate identification information indicating an identity of the media distribution access point;
an information distribution computer coupled to the network, wherein the information distribution computer is operable to distribute information to each media distribution access point of the one or more media distribution access points.

49. The information distribution system of claim 48,
wherein a subset of the one or more distribution access points are coupled to the network in a wired fashion.

50. The information distribution system of claim 48,
wherein a subset of the one or more media distribution access points are coupled to the network in a wireless fashion.

51. The information distribution system of claim 48,
wherein a subset of the output devices are audio output devices.

52. The information distribution system of claim 48,
wherein a subset of the output devices are video output devices.

53. The information distribution system of claim 48,
wherein a first media distribution access point of the one or more media distribution access points is comprised in a first venue;
wherein a second media distribution access point of the one or more media distribution access points is comprised in a second venue.

54. The information distribution system of claim 48,
wherein each media distribution access point in a subset of the one or more media distribution access points is operable to send an identification to the information distribution computer.
